(19) United States
(12) Patent Application Publication
(10) Pub. No.: US 2009/0088894 A1
(43) Pub. Date: Apr. 2, 2009

(54) TRANSPORT SYSTEM CAPABLE OF OPTIMIZING TRANSPORT TIME

(75) Inventor: Takaho TANEMORI, Tokyo (JP)

Correspondence Address: YOUNG & THOMPSON, 209 Madison Street, Suite 500, ALEXANDRIA, VA, 22314, US

(73) Assignee: ELPIDA MEMORY, INC., Tokyo (JP)

(21) Appl. No.: 12/243,294

(22) Filed: Oct. 1, 2008

(30) Foreign Application Priority Data
Oct. 1, 2007 (JP) 2007-257619

(51) Int. Cl. G06F 7/00; G06F 17/00

(52) U.S. Cl. 700/225; 700/228; 701/19

(57) ABSTRACT

A transport system includes a plurality of automated guided vehicles that run on a first track to transport an article, a second track connected to the first track on which the plurality of automated guided vehicles wait, a transport controlling apparatus which calculates transport time by using transport completion information received from the automated guided vehicle, and a vehicle managing apparatus which controls the number of automated guided vehicles running on the first track according to a result of calculation by using transport implementation information containing the transport time and historical data containing a list of the transport implementation information.

This application is based upon and claims the benefit of priority from Japanese Patent Application No. 2007-257619 filed on Oct. 1, 2007, the content of which is incorporated by reference.

### BACKGROUND OF THE INVENTION

1. Field of the Invention

The present invention relates to a transport system, a vehicle managing apparatus, and a transport controlling method that use an automated guided vehicle running on a track to transport an article.

2. Description of Related Art

In some manufacturing lines (e.g., a semiconductor fabrication line), tracks installed on a ceiling extend from automated storages (stockers) to manufacturing apparatuses, and automated guided vehicles running on the tracks transport articles (e.g., semiconductor wafers) from the automated storages to the manufacturing apparatuses.

There have been proposed various kinds of systems designed to reduce a transport time in a situation where a plurality of automated guided vehicles are used to transport articles. Japanese Patent Laid-Open No. 2000-353015 (hereinafter referred to as Patent document 1) discloses an example of such systems.

In a situation where a track for automated guided vehicles includes a main line and a branch line, and automated storages are located along the branch line, if an automated guided vehicle returning to the main line from the branch line after storing an article in the automated storage runs into another automated guided vehicle running on the main line at the junction of the branch line and the main line, one of the automated guided vehicles has to wait for the other to pass through the junction. The system disclosed in Patent document 1 is intended to solve the problem.

The system disclosed in Patent document 1 has a main line having the shape of a loop, a branch line connected to the main line at two points, that is, a branch point and a junction point, a plurality of automated guided vehicles that run in one direction on the main line and the branch line, automated storages located along the branch line, and a transport controller.

In the system disclosed in Patent document 1, in response to a transport instruction from the transport controller, a first automated guided vehicle runs into the branch line from the main line via the branch point and transports the article to the location of the automated storage. The article is carried into the automated storage, and after that, the first automated guided vehicle waits for the next instruction from the transport controller.

Then, when a second automated guided vehicle passes through a communication point that is located upstream of the branch point in the main line, the second automated guided vehicle reports to the transport controller that the second automated guided vehicle has passed through the communication point. In response to the passage report, the transport controller checks the destination of the second automated guided vehicle. Then, if the destination is the location where the first automated guided vehicle is waiting, the transport controller transmits a move instruction to the first automated guided vehicle. In response to the move instruction, the first automated guided vehicle runs back into the main line from the branch line via the junction point and moves to another waiting location designated by the move instruction.

As described above, in the system disclosed in Patent document 1, an automated guided vehicle waiting on the branch line starts moving to the junction point when another automated guided vehicle that receives an instruction to transport an article to the automated storage located along the branch line passes through the communication point. As a result, no waiting time occurs when the automated guided vehicle passes through the junction point, and the transport time is reduced accordingly.

In the case where a plurality of automated guided vehicles are used to transport articles, the number of automated guided vehicles and the transport time are related as shown in FIG. 1, for example. In FIG. 1, dotted line 601 shows a case where the total number of times of transport is 2000, and soild line 602 shows a case where the total number of times of transport is 3000. “Number of times transport” equals number of times that an article has been transported.

As can be seen from FIG. 1, the transport time does not always decrease as the number of automated guided vehicles increases. On the contrary, if there are too many automated guided vehicles, the transport time can increase because of congestion on the track. In addition, as can be seen from FIG. 1, the optimal number of automated guided vehicles can vary with the number of times of transport.

In general, in a manufacturing line in which automated guided vehicles running on a track transport articles, the number of automated guided vehicles is fixed. However, the number of times of transport can vary according to the manufacturing condition, so that there is a problem that the transport time can increase depending on the number of automated guided vehicles.

Patent document 1 also does not disclose any arrangement to control the number of automated guided vehicles according to the number of times of transport. Therefore, it is considered that the problem described above can occur in the system disclosed in Patent document 1.

### SUMMARY

In one embodiment, there is provided a transport system that includes a plurality of automated guided vehicles that run on a first track to transport an article, a second track connected to the first track on which the plurality of automated guided vehicles wait, a transport controlling apparatus which calculates transport time by using transport completion information received from the automated guided vehicle, and a vehicle managing apparatus which calculates the total number of times that the article has been transported and an average value of the transport time from historical data containing a list of transport implementation information including the transport time received from the transport controlling apparatus and controls the number of automated guided vehicles running on the first track according to the total number and the average value.

According to the present invention, the second track connected to the first track for transporting an article on which the plurality of automated guided vehicles wait is provided. In addition, the vehicle managing apparatus monitors the total number of times of the transport and the average value of the transport time and controls the number of automated guided vehicles running on the first track based on the values. Thus, when the number of times of transport varies, the number of automated guided vehicles transporting articles is optimized. As a result, the transport time can be optimized according to the variation of the number of times of transport.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a graph showing a relationship between the number of automated guided vehicles and the transport time;

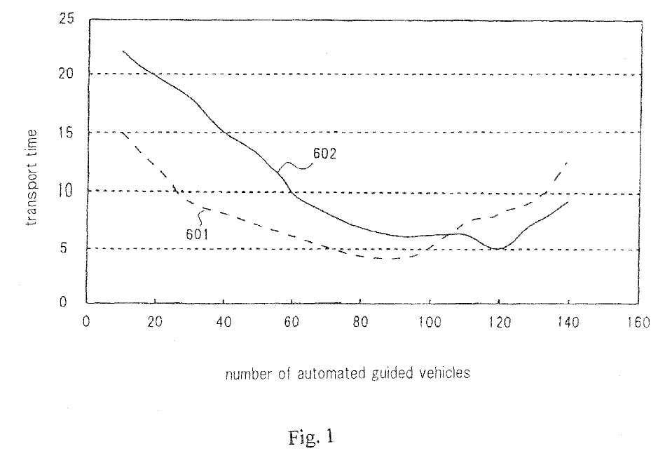

FIG. 2 is a block diagram showing an exemplary configuration of a vehicle managing apparatus and a transport controlling apparatus according to an exemplary embodiment;

FIG. 3 is a diagram showing an exemplary layout of a manufacturing line in a factory in which a transport system according to the exemplary embodiment is used for transport;

FIG. 4 is a diagram showing an example of data stored in a storage section of the transport controlling apparatus according to the exemplary embodiment;

FIGS. 5A and 5B are diagrams showing examples of data stored in a storage section of the vehicle managing apparatus according to the exemplary embodiment; and

FIG. 6 is a flowchart for illustrating a procedure of controlling the number of running automated guided vehicles.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

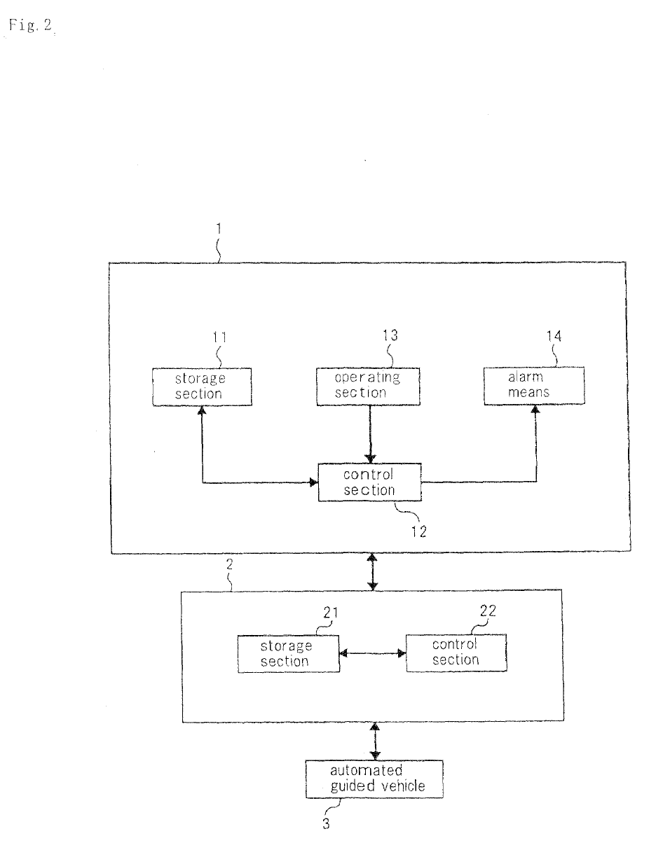

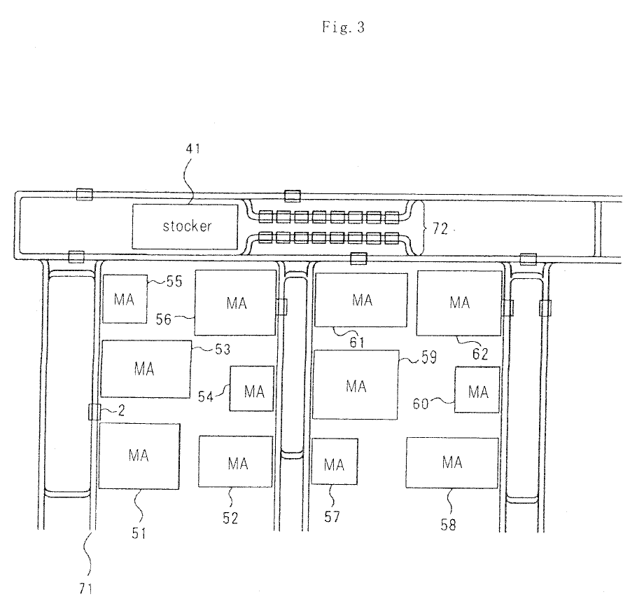

Referring now to FIGS. 2 and 3, a transport system according to a first exemplary embodiment of the present invention includes vehicle managing apparatus 1, transport controlling apparatus 2, a plurality of automated guided vehicles including automated guided vehicle 3, and waiting rail 72 on which the plurality of automated guided vehicle wait.

In addition, in this exemplary embodiment, transport rail 71 and waiting rail 72 shown in FIG. 3 are installed on the ceiling of the factory, and stocker 41 for storing an article and manufacturing apparatuses 51 to 62 are located along transport rail 71. In FIG. 3, a manufacturing apparatus is described as “MA”.

Automated guided vehicle 3 is an automated guided vehicle provided with a suspended transport mechanism, such as an overhead hoist transport (OHT).

When automated guided vehicle 3 receives a transport signal that designates the transport source (stocker 41) and the transport destination from transport controlling apparatus 2, automated guided vehicle 3 runs on transport rail 71 according to the transport signal to transport an article. Then, when the transport is completed, automated guided vehicle 3 transmits transport completion information containing the vehicle ID thereof, the transport start time and the transport end time to transport controlling apparatus 2.

The vehicle ID is intended to identify each of the plurality of automated guided vehicles and is previously assigned to each automated guided vehicle.

If automated guided vehicle 3 receives a removal signal that instructs it to move to waiting rail 72 from transport controlling apparatus 2 when automated guided vehicle 3 is running on transport rail 71, automated guided vehicle 3 moves to waiting rail 72.

If automated guided vehicle 3 receives an entry signal that instructs it to move to transport rail 71 from transport controlling apparatus 2 when automated guided vehicle 3 is waiting on waiting rail 72, automated guided vehicle 3 moves to transport rail 71.

Transport controlling apparatus 2 includes storage section 21 and control section 22.

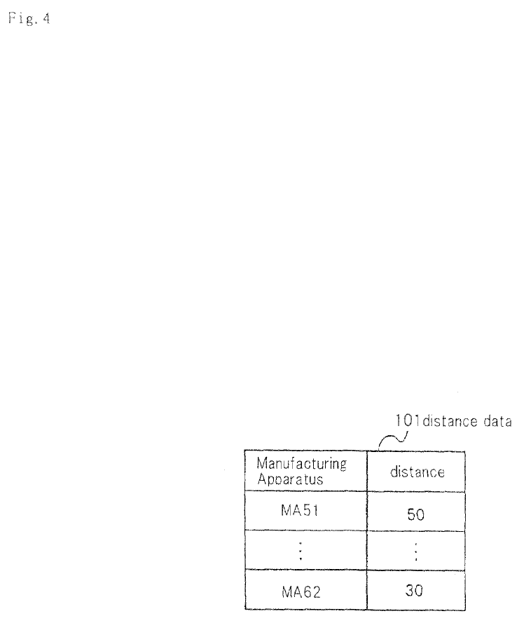

FIG. 4 is a diagram showing an example of data stored in storage section 21.

As shown in FIG. 4, storage section 21 stores distance data 101 that indicates the distance (transport distance) on transport rail 71 from stocker 41 to each of the manufacturing apparatuses 51 to 62 that the automated guided vehicle runs.

When control section 22 receives an instruction to transport an article from a host computer (not shown), control section 22 designates one of the automated guided vehicles on transport rail 71 and transmits a transport signal to the designated automated guided vehicle.

When control section 22 receives transport completion information from an automated guided vehicle, control section 22 calculates the transport time from the transport start time to the transport end time. In addition, control section 22 extracts the transport distance from distance data 101 stored in storage section 21 based on the transport source and the transport destination indicated by the transport signal transmitted to the automated guided vehicle.

Then, control section 22 transmits transport implementation information containing the vehicle ID indicated by the transport completion information, the calculated transport time and the transport distance extracted from distance data 101 to vehicle managing apparatus 1.

Furthermore, control section 22 transmits the removal signal and the entry signal to the automated guided vehicle designated by vehicle managing apparatus 1 under the control of vehicle managing apparatus 1.

Vehicle managing apparatus 1 includes storage section 11, control section 12, alarm means 13 and operating section 14.

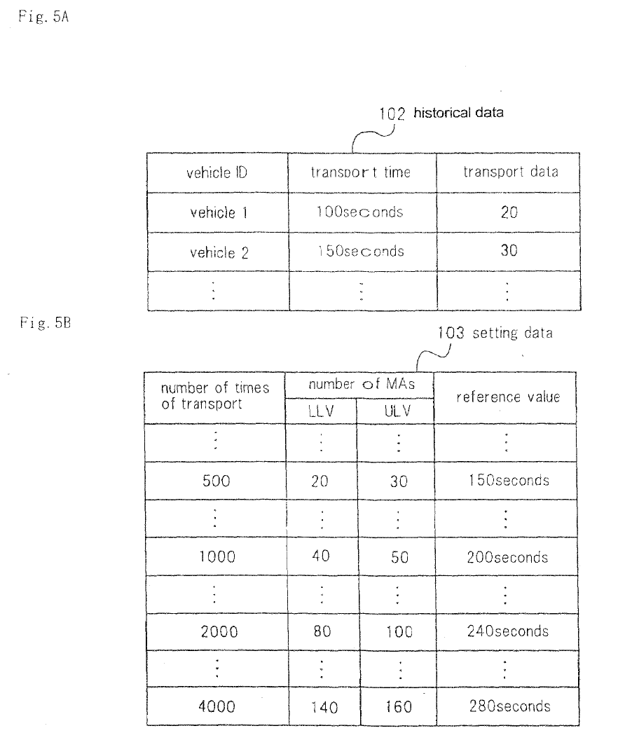

FIGS. 5A and 5B are diagrams showing examples of data stored in storage section 11.

FIG. 5A shows historical data 102 containing a list of transport implementation information. FIG. 5B shows setting data 103 containing upper limit values and lower limit values of the number of automated guided vehicles running on transport rail 71 and reference values of the transport time for different predetermined total numbers of times of transport. In FIG. 5B, upper limit value is described as “ULV”, low limit value is described as “LLV”.

Next, an operation of the transport system according to this exemplary embodiment will be described.

In this exemplary embodiment, it is assumed that automated guided vehicle 3 is running on transport rail 71.

First, an operation of transporting an article will be described.

When control section 22 of transport controlling apparatus 2 receives an instruction to transport an article from the host computer, control section 22 designates one of the automated guided vehicles on transport rail 71 and transmits a transport signal to the designated automated guided vehicle. In this exemplary embodiment, it is assumed that automated guided vehicle 3 is designated.

When automated guided vehicle 3 receives the transport signal, automated guided vehicle 3 transports the article from stocker 41 to any one of manufacturing apparatuses 51 to 62 based on the transport signal. When the transport is completed, automated guided vehicle 3 transmits transport completion information to vehicle managing apparatus 1.

When vehicle managing apparatus 1 receives the transport completion information, control section 12 writes transport implementation information in historical data 102.

In this way, the operation of transporting an article is accomplished.

Next, an operation of controlling the number of automated guided vehicles on transport rail 71 (the number of running automated guided vehicles) will be described.

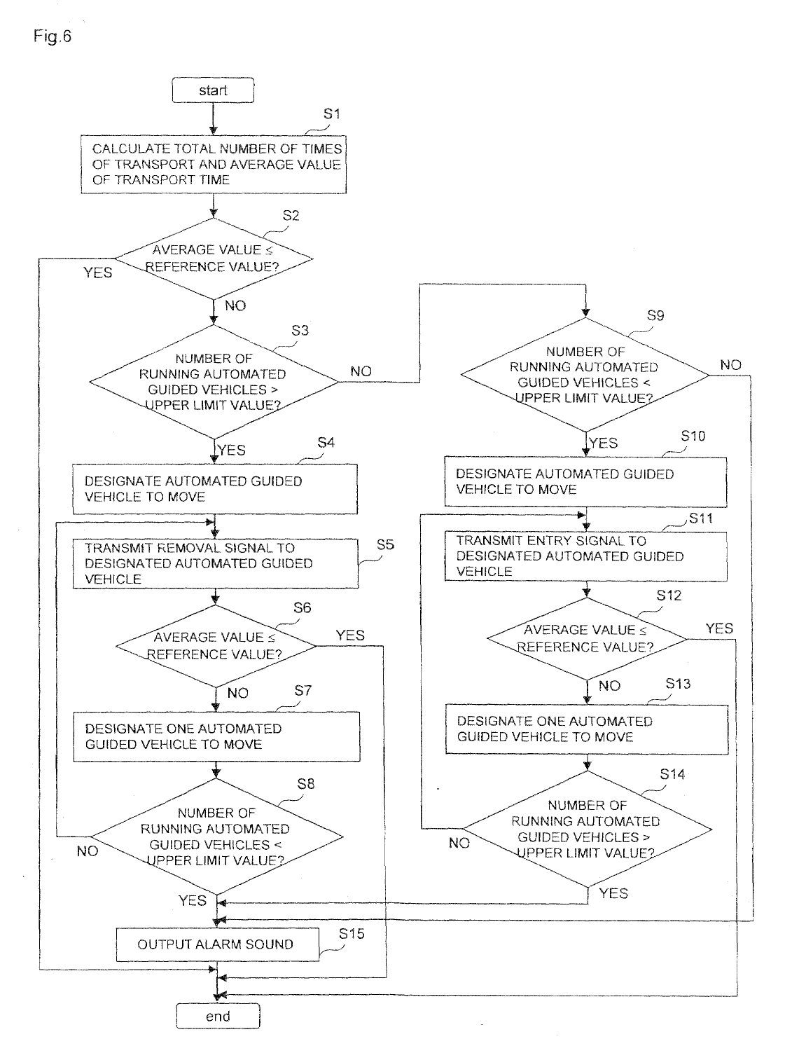

FIG. 6 is a flowchart for illustrating the operation of controlling the number of running automated guided vehicles.

Control section 12 calculates the total number of times of transport and the average value of the transport time from historical data 102 (step S1).

In the processing in step S1, when control section 12 calculates the total number and the average value is not particularly limited. In this exemplary embodiment, it is assumed that the processing in step S1 is performed after a lapse of a predetermined time.

Then, control section 12 determines whether or not the average value is equal to or lower than the reference value associated with the calculated total number by referring to setting data 103 (step S2).

If the average value is higher than the reference value, control section 12 determines whether or not the number of running automated guided vehicles is higher than the upper limit value associated with the calculated total number by referring to setting data 103 (step S3).

If the number of running automated guided vehicles is higher than the upper limit value, control section 12 designates a number of automated guided vehicles on transport rail 71 equal to the number of running automated guided vehicles minus the upper limit value, and transmits an instruction to move the designated automated guided vehicles to waiting rail 72 and the vehicle IDs of the designated automated guided vehicles to transport controlling apparatus 2 (step S4).

Then, control section 22 transmits the removal signal to the automated guided vehicles designated by control section 12 (step S5). When a predetermined time elapses after the automated guided vehicles receiving the removal signal moves to waiting rail 72, control section 22 calculates the average value of the transport time and determines whether or not the average value is equal to or lower than the reference value (step S6).

If the average value is higher than the reference value, control section 12 designates one of the automated guided vehicles on transport rail 71 to move to waiting rail 72 and outputs the move instruction and the vehicle ID of the designated automated guided vehicle to transport controlling apparatus 2 (step S7)

The procedure from step S5 to step S7 is repeated until the number of running automated guided vehicles reaches the lower limit value associated with the upper limit value compared with the number of running automated guided vehicles in the processing in step S3 in setting data 103 (step S8).

If it is determined that the number of running automated guided vehicles is lower than the upper limit value in the processing in step S3, control section 12 determines whether or not the number of running automated guided vehicles is lower than the lower limit value associated with the upper limit in setting data 103 (step S9).

If the number of running automated guided vehicles is lower than the lower limit value, control section 12 designates a number of automated guided vehicles on waiting rail 72 equal to the lower limit value minus the number of running automated guided vehicles, and transmits an instruction to move the designated automated guided vehicles to transport rail 71 and the vehicle IDs of the designated automated guided vehicles to transport controlling apparatus 2 (step S10).

Then, control section 22 transmits the entry signal to the automated guided vehicles designated by control section 12 (step S11). When a predetermined time elapses after the automated guided vehicles receiving the entry signal moves to transport rail 71, control section 22 calculates the average value of the transport time and determines whether or not the average value is equal to or lower than the reference value (step S12).

If the average value is higher than the reference value, control section 12 designates one of the automated guided vehicles on waiting rail 72 to move to transport rail 71 and transmits the move instruction and the vehicle ID of the designated automated guided vehicle to transport controlling apparatus 2 (step S13).

The procedure from step S11 to step S13 is repeated until the number of running automated guided vehicles reaches the upper limit value associated with the lower limit value compared with the number of running automated guided vehicles in the processing in step S9 in setting data 103 (step S14).

If it is determined that the number of running automated guided vehicles is lower than the lower limit value in the processing in step S8, or if it is determined that the number of running automated guided vehicles is higher than the lower limit value in the processing in step S9, or if it is determined that the number of running automated guided vehicles is lower than the upper limit value in the processing in step S14, then control section 12 transmits a control signal to alarm means 13. In response to this, alarm means 13 outputs an alarm sound (step S15).

After alarm means 13 outputs the alarm sound, if a user changes the upper limit value or the lower limit value in setting data 103 through an input operation on a plurality of keys on operating section 14, control section 12 rewrites setting data 103 based on the input.

In the processings in steps S4 and S7, control section 12 designates the automated guided vehicles in descending order of the running distance, which is the total transport distance calculated based on historical data 102. Furthermore, in the processings in steps S10 and S13, control section 12 designates the automated guided vehicles in ascending order of the running distance. If the automated guided vehicles are designated in this way, the running distances of the automated guided vehicles can be made uniform.

In this exemplary embodiment, waiting rail 72 connected to transport rail 71 for transporting an article on which the plurality of automated guided vehicles wait is provided. In addition, vehicle managing apparatus 1 monitors the total number of times of transport and the average value of the transport time and controls the number of automated guided vehicles running on transport rail 71 based on the values. Thus, when the number of times of transport varies, the number of automated guided vehicles transporting articles is optimized. As a result, the transport time can be optimized according to the variation of the number of times of transport.

Furthermore, in this exemplary embodiment, since waiting rail 72 is provided, the distance at which automated guided vehicles, that are not involved in article transport, are wastefully run, is reduced. As a result, deterioration due to wear is reduced, so that the time between maintenance of the automated guided vehicles can be increased. In addition, the cost of electricity to drive the automated guided vehicles is reduced, so that the transport cost can also be reduced.

It is apparent that the present invention is not limited to the above embodiments, but may be modified and changed without departing from the scope and spirit of the invention.

What is claimed is:

1. A transport system, comprising:
a plurality of automated guided vehicles that run on a first track to transport an article;
a second track connected to the first track on which said plurality of automated guided vehicles wait;
a transport controlling apparatus; and
a vehicle managing apparatus,
wherein said plurality of automated guided vehicles transmit transport completion information including a vehicle ID for identification of each of said plurality of automated guided vehicles, a transport start time and a transport end time to said transport controlling apparatus when said automated guided vehicles complete transport of said article under control of said transport controlling apparatus,
said transport controlling apparatus includes a first control section that calculates transport time from said transport start time to said transport end time and transmits transport implementation information including the transport time and said vehicle ID to said vehicle managing apparatus when said transport completion information is received, and
said vehicle managing apparatus includes:
a storage section that stores historical data that contains a list of said transport implementation information; and
a second control section that stores said transport implementation information in said storage section when said transport implementation information is received, calculates the total number of times that said article has been transported and an average value of said transport time from said historical data, and controls the number of automated guided vehicles running on said first track according to said total number and said average value through said transport controlling apparatus.

2. The transport system according to claim 1, wherein in said vehicle managing apparatus,
said storage section stores setting data including an upper limit value and a lower limit value of the number of running automated guided vehicles and a reference value of said transport time previously determined and associated with said total number, and
said second control section reads out said reference value associated with said total number from said setting data, compares said reference value with said average value, reads out said upper limit value associated with said total number and compares said upper limit value with the number of running automated guided vehicles if said average value is higher than said reference value, and designates a number of automated guided vehicles equal to the number of running automated guided vehicles minus said upper limit value among said automated guided vehicles running on said first track and causes said transport controlling apparatus to transmit a removal signal to designated automated guided vehicles to instruct them to move to said second track from said first track, if the number of running automated guided vehicles is higher than said upper limit value.

3. The transport system according to claim 2, wherein in said vehicle managing apparatus,
said second control section reads out said lower limit value associated with calculated said total number from said setting data and compares said lower limit value with said number of running automated guided vehicles if the number of running automated guided vehicles is lower than said upper limit value, and designates a number of automated guided vehicles equal to said lower limit value minus the number of running automated guided vehicles among said automated guided vehicles waiting on said second track and causes said transport controlling apparatus to transmit an entry signal to designated automated guided vehicles to instruct them to move to said first track from said second track, if the number of running automated guided vehicles is lower than said lower limit value.

4. The transport system according to claim 3, further comprising:
a stocker that stores said article; and
a manufacturing apparatus,
wherein said plurality of automated guided vehicles run on said first track and transport said article from said stocker to said manufacturing apparatus,
said transport controlling apparatus includes a storage section that stores distance data that indicates a distance from said stocker to said manufacturing apparatus, and
when said first control section receives said transport completion information, said first control section reads out a transport distance for said automated guided vehicle that transmits said transport completion information from said distance data and transmits said transport distance, said transport time and said vehicle ID to said vehicle managing apparatus as said transport implementation information, and
in said vehicle managing apparatus, said second control section designates said automated guided vehicles running on said first track in descending order of a running distance, which is the sum of said transport distance, based on said historical data, and designates said automated guided vehicles waiting on said second track in ascending order of said running distance based on said historical data.

5. A vehicle managing apparatus that forms a system in conjunction with a plurality of automated guided vehicles that run on a first track and transport an article, a second track connected to said first track on which said plurality of automated guided vehicles wait, and a transport controlling apparatus,
wherein said plurality of automated guided vehicles transmit transport completion information including a vehicle ID for identification of each of said plurality of automated guided vehicles, a transport start time and a transport end time to said transport controlling apparatus when said automated guided vehicles complete transport of said article under control of said transport controlling apparatus,
said transport controlling apparatus includes control means that calculates transport time from said transport start time to said transport end time and transmits transport implementation information including said transport time and said vehicle ID to said vehicle managing apparatus when said transport completion information is received, and
said vehicle managing apparatus includes:
a storage section that stores historical data that contains a list of said transport implementation information; and
a control section that stores said transport implementation information in said storage section when said transport implementation information is received, calculates the total number of times that said article has been transported and an average value of said transport time from said historical data, and controls the number of automated guided vehicles running on said first track according to said total number and said average value through said transport controlling apparatus.

6. The vehicle managing apparatus according to claim 5, wherein said storage section stores setting data including an upper limit value and a lower limit value of the number of running automated guided vehicles and a reference value of said transport time previously determined and associated with said total number, and
said control section reads out said reference value associated with said total number from said setting data, compares said reference value with said average value, reads out said upper limit value associated with said total number from said setting data and compares said upper limit value with the number of running automated guided vehicles if said average value is higher than said reference value, and designates a number of automated guided vehicles equal to the number of running automated guided vehicles minus said upper limit value among said automated guided vehicles running on said first track and causes said transport controlling apparatus to transmit a removal signal to designated automated guided vehicles to instruct them to move to said second track from said first track, if the number of running automated guided vehicles is higher than said upper limit value.

7. The vehicle managing apparatus according to claim 6, wherein said control section reads out said lower limit value associated with calculated said total number from said setting data and compares said lower limit value with said number of running automated guided vehicles if the number of running automated guided vehicles is lower than said upper limit value, and designates a number of automated guided vehicles equal to said lower limit value minus the number of running automated guided vehicles among said automated guided vehicles waiting on said second track and causes said transport controlling apparatus to transmit an entry signal to designated automated guided vehicles to instruct them to move to said first track from said second track, if the number of running automated guided vehicles is lower than said lower limit value.

8. The vehicle managing apparatus according to claim 6, further comprising:
alarm means,
wherein said control section repeats a process including calculating said average value after said removal signal is transmitted, designating one of said automated guided vehicles running on said first track if said average value is higher than said reference value, and causing said transport controlling apparatus to transmit said removal signal to designated automated guided vehicle until the number of running automated guided vehicles reaches said lower limit value and activates said alarm means when the number of running automated guided vehicles becomes lower than said lower limit value.

9. The vehicle managing apparatus according to claim 7, further comprising:
alarm means,
wherein said control section repeats a process including calculating said average value after said removal signal is transmitted, designating one of said automated guided vehicles running on said first track if said average value is higher than said reference value, and causing said transport controlling apparatus to transmit said removal signal to designated automated guided vehicle until the number of running automated guided vehicles reaches said lower limit value and activates said alarm means when the number of running automated guided vehicles becomes lower than said lower limit value.

10. The vehicle managing apparatus according to claim 8, wherein said control section repeats a process including calculating said average value after said entry signal is transmitted, designating one of said automated guided vehicles waiting on said second track if said average value is higher than said reference value, and causing said transport controlling apparatus to transmit said entry signal to designated automated guided vehicle until the number of running automated guided vehicles reaches said upper limit value and activates said alarm means when the number of running automated guided vehicles becomes higher than said upper limit value.

11. The vehicle managing apparatus according to claim 9, wherein said control section repeats a process including calculating said average value after said entry signal is transmitted, designating one of said automated guided vehicles waiting on said second track if said average value is higher than said reference value, and causing said transport controlling apparatus to transmit said entry signal to designated automated guided vehicle until the number of running automated guided vehicles reaches said upper limit value and activates said alarm means when the number of running automated guided vehicles becomes higher than said upper limit value.

12. The vehicle managing apparatus according to claim 6, wherein said plurality of automated guided vehicles run on said first track and transport said article from a stocker to a manufacturing apparatus, and
in the case where said transport controlling apparatus includes storage means that stores distance data that indicates a distance from said stocker to said manufacturing apparatus, and when said control means receives said transport completion information, said first control section reads out a transport distance for said automated guided vehicle that transmits said transport completion information from said distance data and transmits said transport distance, the transport time and the vehicle ID to said vehicle managing apparatus as said transport implementation information,
said control section designates said automated guided vehicles running on said first track in descending order of a running distance, which is the sum of said transport distance, based on said historical data, and designates said automated guided vehicles waiting on said second track in ascending order of said running distance based on said historical data.

13. The vehicle managing apparatus according to claim 7, wherein said plurality of automated guided vehicles run on said first track and transport said article from a stocker to a manufacturing apparatus, and
in the case where said transport controlling apparatus includes storage means that stores distance data that indicates a distance from said stocker to said manufacturing apparatus, and when said control means receives said transport completion information, said first control section reads out a transport distance for said automated guided vehicle that transmits said transport completion information from said distance data and transmits said transport distance, the transport time and the vehicle ID to said vehicle managing apparatus as said transport implementation information,
said control section designates said automated guided vehicles running on said first track in descending order of a running distance, which is the sum of said transport distance, based on said historical data, and designates said automated guided vehicles waiting on said second track in ascending order of said running distance based on said historical data.

14. The vehicle managing apparatus according to claim 8, wherein said plurality of automated guided vehicles run on said first track and transport said article from a stocker to a manufacturing apparatus, and
in the case where said transport controlling apparatus includes storage means that stores distance data that indicates a distance from said stocker to said manufacturing apparatus, and when said control means receives said transport completion information, said first control section reads out a transport distance for said automated guided vehicle that transmits said transport completion information from said distance data and transmits said transport distance, the transport time and the vehicle ID to said vehicle managing apparatus as said transport implementation information,
said control section designates said automated guided vehicles running on said first track in descending order of a running distance, which is the sum of said transport distance, based on said historical data, and designates said automated guided vehicles waiting on said second track in ascending order of said running distance based on said historical data.

15. The vehicle managing apparatus according to claim 9, wherein said plurality of automated guided vehicles run on said first track and transport said article from a stocker to a manufacturing apparatus, and
in the case where said transport controlling apparatus includes storage means that stores distance data that indicates a distance from said stocker to said manufacturing apparatus, and when said control means receives said transport completion information, said first control section reads out a transport distance for said automated guided vehicle that transmits said transport completion information from said distance data and transmits said transport distance, the transport time and the vehicle ID to said vehicle managing apparatus as said transport implementation information,
said control section designates said automated guided vehicles running on said first track in descending order of a running distance, which is the sum of said transport distance, based on said historical data, and designates said automated guided vehicles waiting on said second track in ascending order of said running distance based on said historical data.

16. The vehicle managing apparatus according to claim 10, wherein said plurality of automated guided vehicles run on said first track and transport said article from a stocker to a manufacturing apparatus, and
in the case where said transport controlling apparatus includes storage means that stores distance data that indicates a distance from said stocker to said manufacturing apparatus, and when said control means receives said transport completion information, said first control section reads out a transport distance for said automated guided vehicle that transmits said transport completion information from said distance data and transmits said transport distance, the transport time and the vehicle ID to said vehicle managing apparatus as said transport implementation information,
said control section designates said automated guided vehicles running on said first track in descending order of a running distance, which is the sum of said transport distance, based on said historical data, and designates said automated guided vehicles waiting on said second track in ascending order of said running distance based on said historical data.

17. The vehicle managing apparatus according to claim 11, wherein said plurality of automated guided vehicles run on said first track and transport said article from a stocker to a manufacturing apparatus, and
in the case where said transport controlling apparatus includes storage means that stores distance data that indicates a distance from said stocker to said manufacturing apparatus, and when said control means receives said transport completion information, said first control section reads out a transport distance for said automated guided vehicle that transmits said transport completion information from said distance data and transmits said transport distance, the transport time and the vehicle ID to said vehicle managing apparatus as said transport implementation information,
said control section designates said automated guided vehicles running on said first track in descending order of a running distance, which is the sum of said transport distance, based on said historical data, and designates said automated guided vehicles waiting on said second track in ascending order of said running distance based on said historical data.

18. A transport controlling method that is implemented in a system including a plurality of automated guided vehicles that run on a first track to transport an article, a second track connected to said first track on which said plurality of automated guided vehicles wait, a transport controlling apparatus, and a vehicle managing apparatus, said method comprising:
said plurality of automated guided vehicles transmitting transport completion information including a vehicle ID for identification of each of said plurality of automated guided vehicles, a transport start time and a transport end time to said transport controlling apparatus when said automated guided vehicles complete transport of said article under control of said transport controlling apparatus,
said transport controlling apparatus calculating transport time from said transport start time to said transport end time and transmitting transport implementation information including said transport time and said vehicle ID to said vehicle managing apparatus when said transport completion information is received, and
said vehicle managing apparatus calculating the total number of times that said article has been transported and an average value of said transport time based on data that contains a list of said transport implementation information, and controlling the number of automated guided vehicles running on said first track according to said total number and said average value through said transport controlling apparatus.
